(19) United States
(12) Patent Application Publication
(10) Pub. No.: US 2017/0021505 A1
(43) Pub. Date: Jan. 26, 2017

(54) DEVICE AND METHOD FOR THE AUTOMATED PROCESSING OF WORKPIECES

(71) Applicant: WOBBEN PROPERTIES GMBH, Aurich (DE)

(72) Inventors: Frank KNOOP, Aurich (DE); Rainer SCHLÜTER, Aurich (DE); Thomas MÜNK, Großefehn (DE); Rolf CONERS, Elisabethfehn (DE)

(21) Appl. No.: 15/302,448

(22) PCT Filed: Mar. 25, 2015
(86) PCT No.: PCT/EP2015/056392

§ 371 Date: Oct. 6, 2016

(30) Foreign Application Priority Data
Apr. 7, 2014 (DE) 10 2014 206 683.2

(51) Int. Cl. B25J 11/00; G05B 19/409; G05B 19/402; G05B 11/01; B25J 5/02; B25J 5/06

(52) U.S. Cl. CPC B25J 11/005; B25J 5/02; B25J 5/06; G05B 19/402; G05B 11/01; G05B 19/409; G05B 2219/45058; G05B 2219/45044; G05B 2219/45151; F03D 1/0691

(57) ABSTRACT

An apparatus for automated machining, such as grinding, cutting and/or deburring, of workpieces, in particular of cast components, e.g., of wind turbines. For this purpose, the apparatus comprises a motor spindle for machining the workpiece, the motor spindle having a tool interface for receiving a tool for the machining operation. Moreover, the motor spindle is designed, in particular, to change a tool automatically. In addition, the apparatus comprises a robot for holding and guiding the motor spindle, and a control unit for controlling the motor spindle and the robot. The disclosure additionally relates to a method for automated machining of workpieces.

### BACKGROUND

Technical Field

The invention relates to an apparatus and a method for automated machining, such as, for example, grinding, cutting and/or deburring, of workpieces, in particular of components or large components. Such large components or components are, for example, cast components of wind turbines.

Description of the Related Art

It is frequently necessary, following the first forming production step, for components and, in particular, large components, i.e., very large components of, for example, more than one meter in diameter, to undergo further processing, until they can be used for their ultimate purpose. For example, in the first production step, large components are produced by casting. In this case, a liquefied material such as, for example, iron, with or without further additives, is filled into a negative mold that replicates the component. Following hardening of the cast material and the mold, and removal of the mold, the first production step is then complete, and the desired component has been produced for further processing.

In the production of cast parts, negative molds or molds, or a casting mold, can only be produced up to a certain limit of detail, such that, for example, small openings cannot be replicated in the mold, and are therefore produced in further production or processing steps. Moreover, negative molds are frequently composed of a plurality of assembled individual parts, which are joined to each other by connecting regions or connecting faces. In some cases, such connecting faces may not have been worked with sufficient precision, for example, such that, after hardening, the cast part has surface irregularities such as, for example, burrs at these connection points.

Before undergoing further processing, such hardened cast parts, i.e., components or large components, must be machined, namely, for example, deburred, ground and/or cut.

The components or large components of wind turbines, such as, for example, the rotor hub or the nacelle, are an example of this. The rotor hub constitutes the part of the wind turbine that is rotatably mounted on an axle, the so-called stub axle, and to which the rotor blades are attached. Such a rotor hub has, for example, a plurality of flange circles, to each of which a rotor blade is attached. This requires the flange circle to have a flat surface, in order to ensure that the rotor blade can be mounted in its predefined position for its subsequent use and the associated aerodynamic conditions. Such as required surface cannot be replicated with sufficient precision solely by the casting process, by means of a mold, and must therefore be realized by grinding.

According to the prior art, the said further machining, namely, for example, the deburring, grinding and/or cutting, has hitherto been performed manually, by one or more persons. However, in the case of grinding work, in particular, a very fine dust is produced, which, on the one hand, makes it difficult to see the component and, on the other hand, may result in damage to health if inhaled. Moreover, sharp-edged parts that have been cut off or ground off may fly around during the machining operation. In addition, loud noise is also produced during the machining operation.

There is therefore a need for measures to protect health, and to protect the persons performing the machining operation. Such protective measures are, for example, protective eyewear, special protective clothing and ear protectors. However, such protective measures render the machining operation more difficult, since, for example, sensory organs are impeded by the protective measures. Moreover, the work and the protective measures together are physically very demanding.

### BRIEF SUMMARY

Embodiments are directed to an apparatus for automated machining of workpieces and by a method for automated machining of workpieces.

The apparatus according to one or more embodiments of the invention has a motor spindle for machining the workpiece. The workpiece is, for example, a component or large component such as, for example, a cast component of a wind turbine. The machining comprises, for example, grinding, cutting and/or deburring. The motor spindle has a tool interface, i.e., a tool receiver, for receiving a tool for the machining operation. For this purpose, the tool interface is integrated into the motor spindle. Tools for grinding, cutting and/or deburring, for example, can be received by means of the motor spindle, or by means of the tool interface of the motor spindle. The tools are, for example, grinders, cutting discs, drills or other rotary tools.

The apparatus comprises a robot, in particular a robot arm, for holding and guiding the motor spindle. The robot arm is, for example, a conventional robot arm, such as that used in series production, e.g., in the automobile industry. Moreover, the apparatus has a control unit, by means of which the motor spindle, the tool interface and the robot can be controlled without manual intervention. This means that the control unit undertakes the moving of the motor spindle by means of the robot, and thus guides the tool to the component, and along the component, such that automated machining is effected.

Consequently, because of the present apparatus, it is no longer necessary to use a person to machine the workpiece manually.

According to a preferred embodiment, the motor spindle having the tool interface is designed to pick up, set down and/or change the tool automatically. Thus, a plurality of differing, directly succeeding machining steps are possible without the intervention of a person for the purpose of changing the tool between the machining steps.

According to an embodiment, the apparatus has a travelling carriage, having a travel drive, for moving at least the motor spindle and the robot between a plurality of positions within one or more halls. It is conceivable, for example, for a plurality of separate halls or machining stations, also called cabins, to be separated from each other by gates. These halls can only be accessed through these gates. Advantageously, within each of these halls there is a component to be machined. Owing to the travelling carriage, it is thus possible to move the motor spindle and the robot in or between the halls.

According to a further embodiment, the travelling carriage is a rail vehicle, and the apparatus has rails or tracks for carrying and guiding the travelling carriage. Since the travelling carriage is realized as a rail vehicle, and owing to the position of the rails, the working region of the motor spindle can be defined, such that this working region also simultaneously corresponds to the hazard region in which the robot, comprising the robot spindle, moves. Consequently, outside of this region, there is no risk, in particular to persons, of being affected by the moving robot. The safety measures during the machining operation are thereby increased.

According to a further embodiment, the apparatus comprises an operator cabin, which is also called a driver's cabin, and which is disposed, in particular, at or on the travelling carriage. The operator cabin serves to accommodate at least one operator, in particular on a seat inside the operator cabin. Consequently, the process of machining the component can be performed by one operator, the operator being able to stay protected inside the operator cabin.

According to a further embodiment, the operator cabin has an access door. For the operator, access is only possible via this access door. This means that the cabin is closed apart from the access door. Closed in this context means that only air inlet and air outlet openings are provided, for supplying filtered air and removing stale air from the operator cabin, as well as openings for further lines such as, for example, electrical, pneumatic or hydraulic lines. Consequently, the user in the cabin is reliably protected against dust and dirt. It is possible to work in the cabin without special protective equipment. Moreover, in the case of an operator cabin disposed on the travelling carriage, the machining process can also be observed close to the component, or workpiece—including without protective clothing—without anticipated impairments to health.

According to a further embodiment, the operator cabin is disposed so as to be rotatable on the travelling carriage, in particular independently of a movement of the robot. The rotary movement can be controlled via manual input means of the operator. Consequently, it is possible for the machining process to be observed yet more precisely by the operator, since the latter can orient the operator cabin in the direction in which the machining is being performed. In addition, an ergonomic operator posture is thus possible, since, during observation, the operator can continue to look straight ahead without, for example, having to continually turn his/her head in a particular direction in relation to his/her body.

According to a further embodiment, the apparatus has at least one emergency switch or emergency off switch, which, for the purpose of increasing safety, serves to abruptly switch off the apparatus, in particular a machining operation. One or more emergency off switches are disposed, for example, within the cabin, within the hall, in which the machining is performed, and/or outside of this hall. Emergency off switches in front of the hall are advantageous, since the hall has observation windows, and consequently an emergency situation can also be noticed outside of the hall.

According to a further embodiment, the apparatus has a presence switch within the cabin, and has a door contact for monitoring the operator cabin door. The door contact and the presence switch serve to increase safety. This is due to the fact that, because the operator, after entering the operator cabin, closes the door and actuates the present switch, it is ensured that the operator is no longer in the working region, but inside the cabin. Owing to the presence switch and the door contact, a signal to enable the machining operation, for example, can be transmitted to the control unit, after it has been ensured that the operator is inside the operator cabin, and is no longer in the working region.

Additionally provided, moreover, according to a further embodiment, is at least one gate contact of the hall gate or gates, in order to ensure additionally that no other person apart from the operator enters the hall, in particular during the machining operation. The door contact and the gate contact are coupled, for example, to the emergency off switch, such that opening of the operator cabin door and of a hall gate results in the triggering of a sudden stoppage of the machining operation, i.e., an abrupt switch-off of the apparatus.

According to a further preferred embodiment, the apparatus has a tool cabinet, which is disposed, in particular, on the travelling carriage. The tool cabinet serves to store one or more tools, which can be picked up by means of the tool interface of the motor spindle. According to a particular embodiment, the tool cabinet has an automatic door, e.g., a roller shutter, which can be opened and closed by means of the control unit. The tool cabinet thus protects the tool against soiling and, owing to the automatic door, the tool can be changed, picked up or set down automatically.

Moreover, the apparatus preferably has at least one laser, for measuring distances between at least one predefined point of the robot and at least one further point of the workpiece. The laser thus assists gauging of the workpiece. Gauging determines the exact position and orientation of the workpiece, by means of the control unit. By means of the laser, following gauging, the robot and/or the motor spindle can thus be guided selectively to predefined points of the workpiece for machining.

According to a further embodiment, the apparatus has at least one camera, for transmitting images of the workpiece to the control unit, which camera, in particular, is fixedly attached to the robot arm. According to a further embodiment, at least one second camera is provided, which can be disposed in a plurality of positions on the robot, for transmitting images of the workpiece to the control unit from a plurality of positions. By means of these cameras, in particular also with the aid of the laser, it is possible for the workpiece, or component to be machined, to be checked in respect of dimensions, or gauged, with precision, such that, following the dimensional checking—in the case of the position of the component or workpiece being unchanged—the tool can be guided with precision in the tool interface on or to the component, or workpiece.

For the purpose of dimensional checking of complex components, or workpieces, the second camera, which can be disposed in a plurality of positions, can be attached in various regions of the robot, i.e., for example, of the robot arm, or of the motor spindle, during the gauging operation. According to a further exemplary embodiment, gauging is effected automatically, by means of the control unit, the laser and the two cameras, the automatic gauging being interrupted, however, if, for example, the second camera has to be transferred to a new position. According to a further exemplary embodiment, automatic shifting of the second camera between a plurality of positions is additionally provided.

According to a further embodiment, the apparatus has a monitor, which is disposed, in particular, in the operator cabin. The monitor displays the images, recorded by the camera or cameras, to the operator. A yet more precise observation of the machining operation by the operator is thus possible.

A further advantageous embodiment provides that a cooling system, for cooling the motor spindle, is disposed on the travelling carriage, in the region of the motor spindle, or of the robot. The cooling system is, in particular, a water cooling system. It is advantageous to dispose the water cooling system directly in the region of the travelling carriage, since the cooling liquid can thus be prepared and supplied directly in the region of the motor spindle.

Consequently, the individual halls or hall portions in which the machining is performed need not be equipped with individual connections for supplying a cooling medium, but, rather, the apparatus can effect cooling, as it were, autonomously.

According to a further embodiment, the apparatus has an input device, in particular disposed in the operator cabin. The input device is, for example, an input device that is combined with an output device, such as, for instance, a touchscreen. The input device is used for inputting manual commands to the control unit. For this purpose, the input device is connected to the control unit. The input device can be used, for example, to select and start one or more machining operations. In this case, advantageously, the components are displayed directly on the input device, such that the individual machining steps are also represented visually.

According to a further embodiment, the apparatus has one or more access request switches and/or pause function switches. These switches are used to request access to the working region of the motor spindle, in particular to the hall in which the workpiece is being machined. As a result of actuation of the access request switch or of the pause function, the machining operation is at first continued up to a predefined machining step, and only then is the machining operation stopped in a defined, safe state. A signal is output, which signals to the operator, or to a person waiting in front of the hall, that access to the working region is now possible without, for example, the need to trigger an emergency stop.

According to a further embodiment, the robot and/or the control unit has/have a delimiting circuit, which limits the movement of the robot to regions that do not include the region of the operator cabin. In the event of incorrect programming of the robot movement, therefore, the operator cabin is protected against being destroyed or damaged by the robot arm.

According to a further particular embodiment, the apparatus has switches and pushbuttons that can be actuated, in order to move the travelling carriage before the machining operation and, for example, to move the robot, during gauging of the workpiece, or component, by means of the camera attached to the robot arm, into one or more favorable positions that allow gauging of the workpiece. If, for example, an automatic gauging by means of the controller, or control unit, is identified by the control unit as being incorrect, the actuating means are released for the operator, such that the latter can guide the camera or cameras into favorable positions, to enable automatic gauging of the component, or workpiece, to be performed over again.

According to a further embodiment, the apparatus has a main switch for interrupting and establishing the supply energy to the apparatus, this main switch having a securing means, e.g., a lock, for securing the main switch. Consequently, following the machining operation, the supply energy to the apparatus can be interrupted and can be secured, by means of the lock, against being switched on again in an unauthorized manner. The apparatus is thus protected against access by non-authorized persons, and measures against possible injury resulting from improper use are thereby prevented to the greatest possible extent.

The method according to the invention comprises a plurality of steps for machining workpieces. Firstly, a travel step serves to move the travelling carriage of the apparatus according to one of the above-mentioned embodiments to the workpiece. In a gauging step, the workpiece is then gauged by use of at least one fixed camera and/or at least one camera that is positionable in a plurality of positions and/or a laser, by means of a control unit. This means that, after the travel step, the travelling carriage, which comprises, in particular, the robot and the motor spindle, has been disposed in the region of the workpiece. From this instant onwards, only relative movements between parts of the robot, e.g., an arm of the robot, and the component are possible, such that, following a gauging of the component, any predefined points of the workpiece can be approached by the motor spindle, or the robot. The position of the workpiece is thus, as it were, mapped for the control unit and/or in the control unit by the gauging operation.

The method additionally has a machining step in which the workpiece is machined, i.e., in particular, ground, cut and/or deburred, by means of a motor spindle disposed on the robot.

According to an embodiment of the method, the latter has a preparation step, which follows the travel step and precedes the gauging step, and in which the components of the apparatus that are disposed on the travelling carriage are prepared for the machining operation. Such preparations are, for example, the closing of one or more hall gates, and the connecting of the apparatus to supply lines, e.g., for delivering a compressed air supply. In addition, in the preparation step, the control unit is connected, for example, to emergency off switches and to gate contacts of the hall in which the machining operation is to be effected. As a result of the preparation step, in particular the control unit as well as the robot arm and the motor spindle are integrated with the hall and with the infrastructure available in the hall, as a machining unit.

According to an embodiment, the method comprises a monitoring step, which can be effected, for example, during the entire machining operation, and in which the presence of the operator in the cabin, and/or access to the hall in which the workpiece or component is being machined, is monitored. This is done, for example, by means of a plurality of gate contacts of the hall gate or gates that are connected to the control unit. In the event, for example, of unauthorized entry into the hall, an emergency halt or emergency stoppage of the robot and of the motor spindle can thus be initiated by the control unit. The monitoring step also serves to ensure that the operator is safely in the cabin before the machining of the workpiece commences. For this purpose, door contacts and a presence switch, for example, are provided in the cabin. The operator must thus first enter the cabin, or operator cabin, and close the door, such that the door contact, for example, is closed. Following actuation of the presence switch, the control unit then allows the machining operation to be started. Measures are thereby implemented to prevent injury to persons.

According to a further embodiment of the method, a workpiece selection step and/or a program selection step are/is provided. In this workpiece selection step, an input device, e.g., a touchscreen, is used to communicate one or more commands to the control unit, such that the latter receives default settings for the machining step. For this purpose, in the workpiece selection step, one of a plurality of predefined workpieces is selected, for example, namely, the workpiece that is actually to be machined, such that the gauging of the component is facilitated for the gauging step.

The operator can use the program selection step to select one or more predefined machining steps and/or the associated predefined regions of the workpiece, which are then processed automatically by the control unit. It is possible, for example, to select cutting with subsequent grinding of a particular region, such that this cutting with subsequent grinding is performed automatically, without any intervening interruption.

According to a further embodiment of the method, the gauging step has one or more correction steps, in which the manual positioning of the robot is enabled by means of a remote control for positioning the robot. Consequently, if the automatic gauging is not successful, the robot, with a camera for gauging attached thereto, can be moved into a favorable position by a user, by means of the remote control.

According to a particular embodiment, the machining step has a cutting step, in which cuts are made in parts of the workpiece, and/or a parting step, in which parts of the workpiece are parted off, and/or a grinding step, in which parts of the workpiece are ground.

According to a further embodiment, the method has a tool change step, in which a tool is automatically inserted in a tool interface of the motor spindle, removed from the tool interface or changed within the tool interface. For this purpose, according to a preferred embodiment, the tool interface is brought by means of the robot, for example, into the region of the automatically opening tool cabinet, or of tool holders in the tool cabinet. It is thus possible for the tool to be changed without intervention by an operator.

According to a further embodiment, the method has a step in which, as a result of actuation of an emergency off switch, the apparatus is instantaneously stopped in its current position, in order to prevent injury. According to a further embodiment, the method has an access request step, in which access to the working region of the apparatus is requested by means of an access request switch or a pause function switch, and the machining operation stops, not instantaneously, but only upon attainment of a predefined machining state, and then enables access, e.g., by means of a signal. It is then possible—without tripping an emergency off circuit—to access the region in which the workpiece is machined.

### BRIEF DESCRIPTION OF THE SEVERAL VIEWS OF THE DRAWINGS

The invention is described in greater detail in the following on the basis of exemplary embodiments and with reference to the accompanying figures. There are shown in:

FIG. 1 a view of an exemplary embodiment of the apparatus;

FIG. 2 an enlarged representation of an exemplary embodiment of the robot comprising a motor spindle;

FIG. 3 an enlarged view of an exemplary embodiment of the motor spindle;

FIG. 4 a view of an exemplary embodiment of the operator cabin;

FIG. 5 a view of an exemplary embodiment of the tool cabinet, and

FIG. 6 a view of an exemplary embodiment of the apparatus in the case of a machining step of an exemplary embodiment of the method.

### DETAILED DESCRIPTION

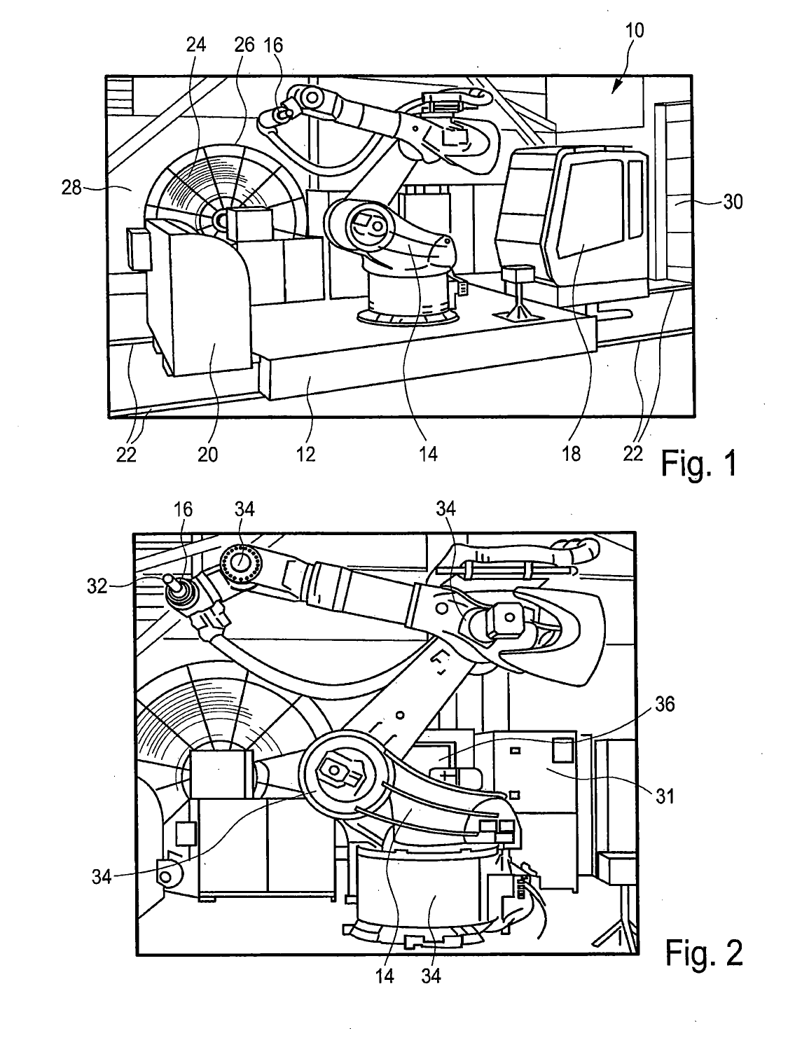

FIG. 1 shows an exemplary embodiment of the apparatus 10 for executing an exemplary embodiment of the method according to the invention. The apparatus 10 comprises a travelling carriage 12, on which further components of the apparatus 10 are disposed. In particular, a robot 14 comprising a motor spindle 16, and an operator cabin or driver's cabin 18 and a tool cabinet 20 are disposed on the travelling carriage 12. The travelling carriage 12 has a travel drive, not represented, and can be moved on tracks or rails 22. During travel, i.e., in travel steps, along the rails 22, a trailing cable 24 is reeled up or reeled off by means of a cable reel 26, according to the direction of movement on the tracks 22. The apparatus 10 is located in a hall 28, which can be entered or exited through a gate 30, only a portion of which is represented. By means of the travelling carriage 12, the apparatus 10 can be moved into the hall 28 and moved out of the hall 28, through the gate 30. By means of the tracks 22 and the travelling carriage 12, it is possible to move the robot 14, with the motor spindle 16, into the region of a workpiece, e.g., a cast component of a wind turbine. The robot 14 then holds and guides the motor spindle 16 for the purpose of machining the workpiece. During the machining operation, the motor spindle 16 is cooled by means of a water cooling system 31.

FIG. 2 shows an enlarged representation of the robot 14 comprising the motor spindle 16. The motor spindle 16 has a tool interface 32 for receiving tools that are used to machine a workpiece. The robot 14 has a plurality of joints, in particular revolute joints 34, in order to move or guide the motor spindle on any paths before and during the machining operation, or in machining steps. Before the machining operation, such movements by means of the joints 34 are necessary in order to gauge the workpiece in one or more gauging steps. Remarks relating to gauging follow in the explanations relating to FIG. 3. Also represented is a control unit 36 that, by operating the joints 34, moves the robot 14 in such a manner that the motor spindle 16 can be moved on predefined paths. For this purpose, the control unit 36 is pre-programmed for one or more different workpieces, one or more different regions of the respective workpiece or workpieces, and one or more different types of machining of the respective region or regions.

FIG. 3 shows an enlargement of the motor spindle 16 from FIG. 2. A first camera 38 is fixedly mounted on the motor spindle 16. A second camera 40 can be disposed at various positions of the motor spindle 16, and for this purpose can be mounted and demounted particularly easily. Here, the second camera 40 is represented only in a first position. In addition, a laser 42 is attached to the motor spindle 16.

Before the machining of a workpiece by means of a tool received by the motor spindle 16, the workpiece is measured out, or gauged, to enable the apparatus 10 to perform precise machining. For the purpose of this gauging, the cameras 38, 40 and the laser 42 are attached to the motor spindle 16. The measuring-out of the workpiece is effected automatically, in that the cameras 38, 40 and the laser 42 transmit their acquired information to the control unit 36, and this acquired information in the control unit 36 determines, from the information or data, the relative position of the motor spindle 16 in relation to the workpiece. Moreover, the cameras 38, 40 serve for hazardless, close-proximity observation during the machining of the workpiece. According to an exemplary embodiment, the second camera 40 has a laser, which likewise serves for gauging. The second camera 40 has to be demounted following the gauging operation, or gauging step, and mounted before the gauging operation, since otherwise it would be in the working during the machining of the workpiece. According to an embodiment that is not represented here, the “mounting” and “demounting” are effected by moving the second camera 40 into differing positions in an automated manner, such that gauging is effected entirely automatically.

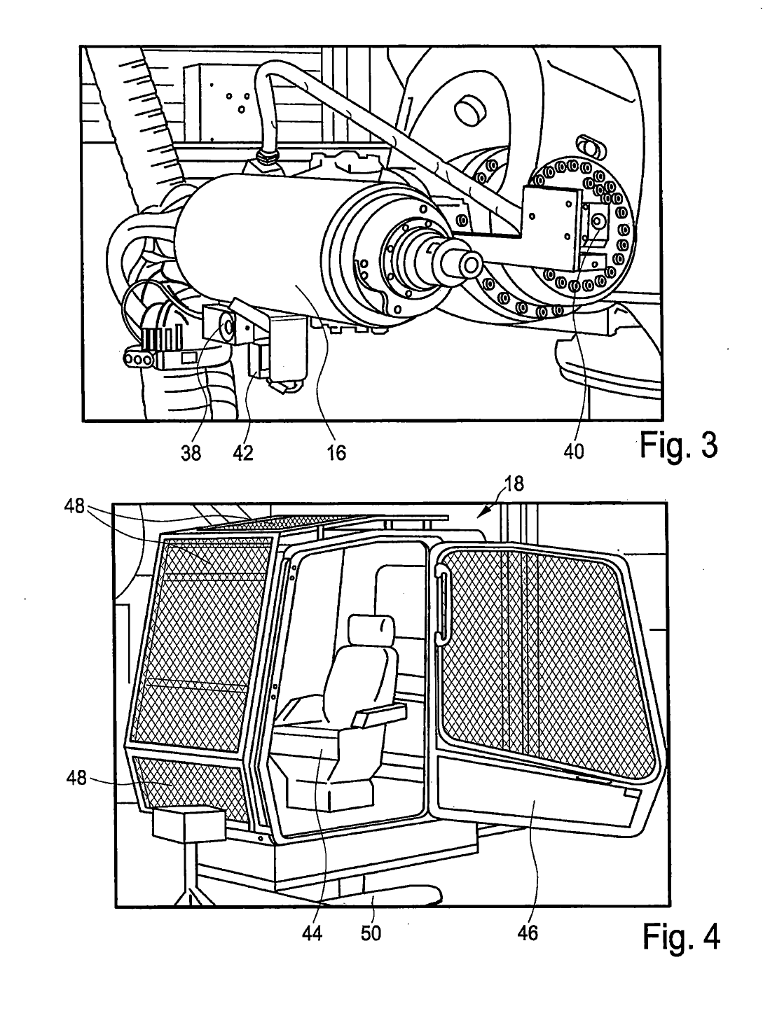

FIG. 4 shows the driver's cabin, or operator cabin 18. The driver's cabin has a seat 44 for the driver, and has a cabin door 46. During the machining operation, the cabin 18 protects a driver or operator against dust and noise. The driver's cabin 18 additionally has protective grilles 48, in order also to protect the operator against parts that become detached and fly around during the machining operation. All operating elements for the automatic operation and manual operation of the machine, including monitors for control and monitoring, are located in the driver's cabin 18. In addition, the seat 44 provides an ergonomically favorable position and protection against flying parts. According to an exemplary embodiment, the operator cabin 18 additionally has protective glass panes, instead of conventional panes, in order to offer addition protection against flying parts. A step 50 allows ease of access to the driver's cabin 18. By means of a pedal control, not represented, the driver's cabin 18 can be rotated by up to 180°, thereby enabling the operator always to face towards the tool in the motor spindle 16, without having to turn in an ergonomically unfavorable manner on the seat 44. The cabin 18 can be rotated into the travel direction for the purpose of moving the travelling carriage 12.

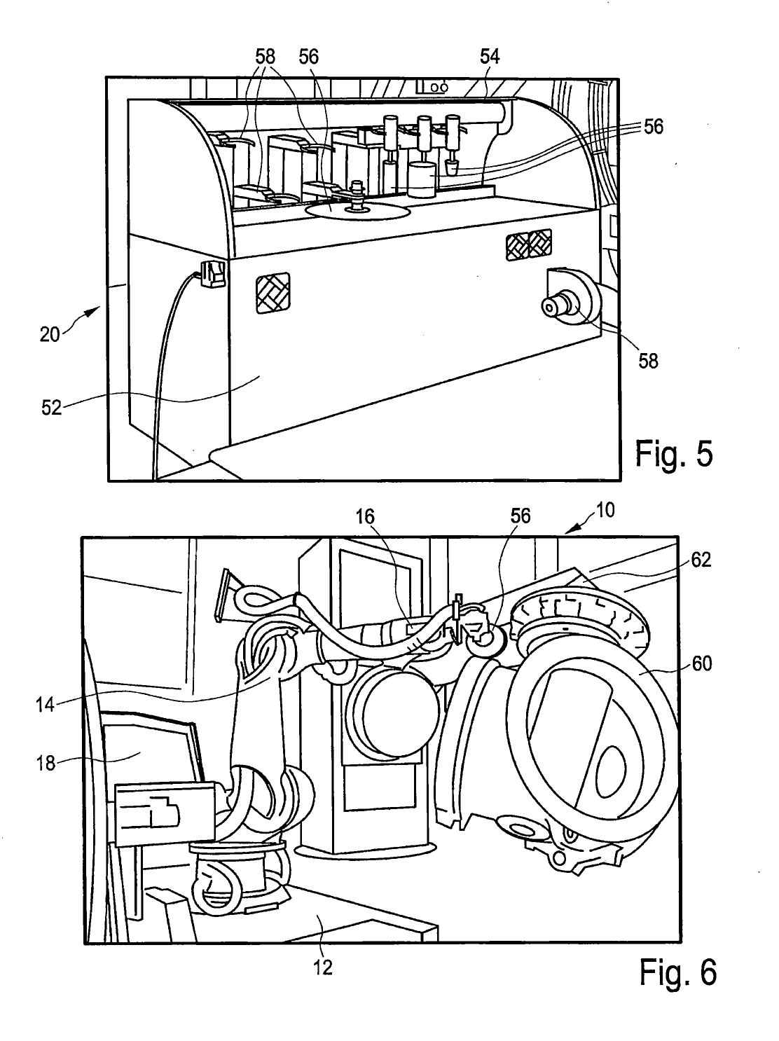

FIG. 5 shows the tool cabinet 20, which comprises a housing 52. Here, the tool cabinet 20 is shown open, but it can be closed at the top by means of a roller shutter 54. The tools 56 are thus stored in the tool cabinet 20 to protect them against dirt, in particular on the part that is received by the tool interface. The tools 56 are, for example, cutting and grinding tools. The tools 56 are automatically removed from the tool holders 58, and set down therein, by the robot 14. The roller shutter 54 is automatically opened and closed for this purpose. Mounted in the lower part of the tool cabinet 20 is a frequency converter, which is ventilated by means of a ventilation system in order to prevent damage resulting from overheating. The frequency converter serves to operate the motor spindle 16.

FIG. 6 shows the apparatus 10 during the machining of a workpiece 60. For this purpose, the workpiece 60 is fixedly mounted on a turnover positioner 62, also called a manipulator. According to an exemplary embodiment, the manipulator 62 is a constituent part of the apparatus 10. The robot 14 in this case guides the motor spindle 16, with the received tool 56, along the region of the workpiece 60 to be machined. This process is effected automatically, according to the default settings of the control unit 36.

It is thus possible for the workpiece 60 to be machined in a substantially automatic manner, without the need for grinding or cutting to be performed manually by a person. Machining of the workpiece is thus effected with maintenance of stringent safety measures and with consideration of the health of personnel.

1. An apparatus for automated machining of workpieces, that are cast components of wind turbines, the apparatus comprising:
a motor spindle for machining the workpiece, the motor spindle having a tool interface for receiving a tool for performing a machining operation, and the tool interface being configured to pick up, set down, and change the tool automatically,
a robot for holding and guiding the motor spindle, and
a control unit for controlling the motor spindle and the robot.

2. The apparatus according to claim 1, further comprising:
a travelling carriage, having a travel drive for moving the motor spindle and the robot between a plurality of positions within one or more halls, and
tracks or rails for carrying and guiding the travelling carriage.

3. The apparatus according to claim 1, further comprising an operator cabin for accommodating at least one operator, the operator cabin having at least one access door, the operator cabin being disposed so as to be rotatable on the travelling carriage, independently of a movement of the robot.

4. The apparatus according to claim 3, comprising at least one of the following:
an emergency off switch disposed in the operator cabin for interrupting a machining step,
a presence switch disposed in the operator cabin for confirming presence inside the operator cabin,
at least one door contact for monitoring at least one operator cabin door, and
at least one gate contact for monitoring at least one hall gate.

5. The apparatus according to claim 1, comprising a tool cabinet for storing one or more tools, the tool cabinet having an automatic door or a roller shutter that is configured to be opened and closed by the control unit.

6. The apparatus according to claim 1, comprising at least one laser for measuring distances between at least one predefined point of the robot and at least one point of the workpiece.

7. The apparatus according to claim 1, comprising at least one of the following:
a first camera for transmitting images of the workpiece to the control unit,
a second camera configured to be disposed in a plurality of positions on the robot or the motor spindle for transmitting images of the workpiece to the control unit, and
a monitor for displaying the images recorded by the camera or cameras.

8. The apparatus according to claim 1, comprising a cooling system for cooling the motor spindle.

9. The apparatus according to claim 1, comprising an input device for transmitting commands, that are input manually, to the control unit.

10. The apparatus according to claim 1, wherein the control unit has a delimiting circuit for delimiting movement of the robot.

11. The apparatus according to claim 1, comprising at least one of access request switches, a pause function, and a pause function switch, for requesting access to a region in which the workpiece is being machined.

12. The apparatus according to claim 1, comprising a manipulator for receiving a workpiece.

13. A method comprising:
automated machining of workpieces of a workpiece that is a cast component of wind turbines, the automated machining comprising the steps:
a travel step, in which a travelling carriage of the apparatus according to claim 2 is driven to the workpiece,
a gauging step, in which the workpiece is gauged by at least one of a camera and a laser,
a machining step, in which the workpiece is machined by the motor spindle in accordance with a default settings of the control unit.

14. The method according to claim 13, comprising a preparation step, in which, after the travel step and before the gauging step, the apparatus is prepared for the machining operation by closing of at least one hall gate and the connecting of the apparatus to one or more supply lines and data lines.

15. The method according to claim 13 comprising at least one of a workpiece selection step program selection step, in which commands are sent to the control unit by an input/output device in response to one of a plurality of predefined workpieces is selected and one or more of predefined machining programs are selected.

16. The method according to claim 13, the gauging step having a correction step, in which the control unit enables the manual positioning of the robot in order to control the robot manually with the aid of a remote control during the gauging step and to intervene in the automatic gauging.

17. The method according to claim 13, the machining step having a pre-cutting step, in which parts of the workpiece are pre-cut, a parting step, in which parts of the workpiece are parted off, and a grinding step, in which parts of the workpiece are ground.

18. The method according to claim 13, the method having a monitoring step for monitoring the presence of an operator in the operator cabin and for monitoring access to the hall in which the workpiece is being reworked.

19. The method according to claim 13 comprising a rotation step in which the operator cabin is rotated by actuation of at least one of manual switches and pushbuttons.

20. The method according to claim 13, the machining step having at least one tool change step in which a tool is automatically inserted in a tool interface of the motor spindle or delivered from the tool interface, the tool interface brought, by the robot, into the region of an automatically opening tool cabinet.
